(19) United States
(12) Patent Application Publication
(10) Pub. No.: US 2007/0076101 A1
(43) Pub. Date: Apr. 5, 2007

(54) Self-calibrating and/or self-testing camera module

(76) Inventor: Richard L. Baer, Los Altos, CA (US)

Correspondence Address: AVAGO TECHNOLOGIES, LTD., P.O. BOX 1920, DENVER, CO, 80201-1920, US

(21) Appl. No.: 11/239,851

(22) Filed: Sep. 30, 2005

(51) Int. Cl. H04N 5/225

(52) U.S. Cl. 348/222.1; 348/207.99

(57) ABSTRACT

Improved digital camera module incorporating circuitry for self-test and calibration. The digital camera module incorporates an image sensor, an image processor using volatile working memory and non-volatile memory containing correction data to produce corrected images during normal device operation. During test and calibration, a calibration processor takes image sensor data and produces correction data which is stored in the non-volatile memory.

### BACKGROUND OF THE INVENTION

1. Field of the Invention

The present invention pertains to the art of digital camera modules, and more particularly, testing and/or calibrating digital image sensors used in digital camera modules.

2. Art Background

Digital camera modules designed around CCD or CMOS image sensors have decreased in price and increased in quality and capability, making them desirous to include in small electronic devices and systems. In this context, a digital camera module is an assembly which converts an image to a set of electrical signals; such modules are then included in more complex assemblies such as digital cameras, webcams, digital phones, and the like. A digital camera module may or may not include lenses, and may contain one or a plurality of integrated circuits.

As manufacturing processes are not perfect, the actual performance of real-world image sensors used in digital camera modules may deviate from the perfection described on manufacturer's specification sheets. Testing and/or calibration is performed on camera modules by presenting the module with a known set of input conditions and noting deviations from expected outputs. These tests may be performed on the module alone, or on the combined module and lens assembly. Even if these tests are not performed for device calibration, the same basic procedure must be used for qualification testing. An image must be collected under known conditions and the output of the module analyzed to determine whether the module passes or fails qualification criteria.

Calibration may be used to correct for either the individual characteristics of a camera module, or for the average characteristics of a group of modules. The former approach is generally used for high-value image modules such as those used in high-end image capture applications such as digital cameras, while the latter approach is more likely to be used for lower-end devices such as camera modules destined for webcams and digital phones.

When individual calibration is performed, applying the calibration procedure to each and every device, corrections can also be developed and applied for individual devices. Where calibration is performed over a group of devices, corrections can be developed for the average device. Individual testing takes time, and time equals cost. The test system must provide a high-bandwidth connection between the imaging device and the system used for processing the resulting image data and comparing the resulting data to desired or expected results. If devices are to be tested in parallel, at least the high bandwidth connection must be replicated for each device to be tested in parallel.

What is needed is a way to simplify and speed up digital camera module calibration and test.

### SUMMARY OF THE INVENTION

A digital camera module includes additional circuitry to support built-in self-test and calibration. The camera module incorporates an image sensor, a calibration processor with volatile working memory, non-volatile correction memory, and an image processor for correcting data from the image sensor.

### BRIEF DESCRIPTION OF THE DRAWINGS

The present invention is described with respect to particular exemplary embodiments thereof and reference is made to the drawings in which:

FIG. 1 shows a digital camera module calibration system as known to the prior art,

FIG. 2 shows the block diagram of an improved digital camera module according to the present invention, and

FIG. 3 shows a block diagram of a test setup.

### DETAILED DESCRIPTION

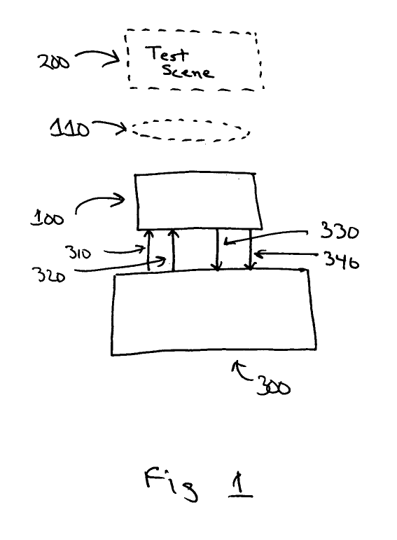

FIG. 1 shows a test setup for performing external calibration and test of a digital camera module as known to the art. In operation, module 100 is presented with test image 200. Module 100 may include a lens, or an external lens 110 may be provided as part of the test setup. Testing and calibration is controlled by computer system 300 which provides DC power 310 and control signals 320 to module 100, receives image data 330 from module 100, and calculates correction coefficients 340 for storing with module 100.

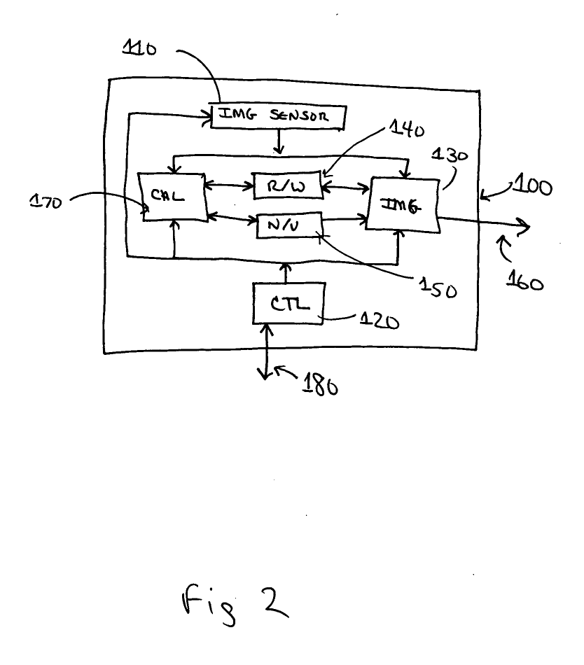

FIG. 2 shows an improved digital camera module 100 according to the present invention. Image sensor 110 operates under the control of control logic 120. Image data from sensor 110 is sent to image processor 130 and calibration processor 140. In operation, image processor 130 uses volatile working memory 140 and non-volatile correction memory 150 to correct data from sensor 110, producing corrected image data 160. During self-test or calibration, as set by control logic 120 in response to control interface 180, calibration processor 170 takes raw image data from sensor 110. During self-test or calibration, this data is expected to correspond to a preselected test image. Calibration processor 170 uses this raw data and test/calibration algorithms to produce correction coefficients which are stored in non-volatile correction memory 150. Control interface 180 may be used to select different modes, such as a raw imaging mode in which data from image sensor 110 is passed uncorrected through image processor 130 to output 160, a normal imaging mode in which data from image sensor 110 is corrected by image processor 130 producing corrected image data at output 160, self-test modes, and calibration modes for responding to different calibration images.

An embodiment of the improved digital camera module 100 according to the present invention may be made by integrating a programmable digital signal processor (DSP) onto the integrated circuit die with image sensor 110. Volatile memory 140 and non-volatile correction memory 150 need to be sized appropriately for image sensor 110 and the nature of the corrections to be applied. Typical embodiments for volatile memory 140 are static or dynamic RAM known to the art. A typical embodiment for non-volatile correction memory 150 would be EEPROM, FLASH, or write-once memory such as fuse memory as known to the art. Calibration processor 170 may be a portion of the DSP used for image processor 130, or it may be a separate logic block. Similarly, control logic 120 may be implemented as a portion of the DSP, or may be a separate logic block. While image sensor 110 may be present as a separate die within module 100, the entire module may be produced as a single integrated circuit.

Control interface 180 will comprise a set of signal lines including clock signals, mode selection signals, and status signals. Mode selection and status may be implemented as a set of fixed lines, bidirectional lines, or through a higher-level serial protocol such as I2C, SPI, or the like. A combination may also be used, such as a single dedicated line to select between normal imaging mode, in which case other mode select signals such as I2C, SPI, etc., would be ignored, and self-test/calibration mode in which case other mode select signals are active.

Specific test images and their corresponding algorithms are executed to perform different calibrations and tests. Examples include dark fields (no illumination) and flat fields (uniform illumination) of different color temperatures. More complex images and tests are used to calibrate optical distortion and focus.

A dark frame algorithm is used in conjunction with a dark field (no illumination) to correct for types of fixed pattern noise in sensor 110. Fixed pattern noise typically appears as isolated bright pixels or as bright rows or columns. In one implementation, the locations of the brightest isolated pixels are stored in a table in non-volatile correction memory 150 during the calibration procedure. This process is performed according to the structure of sensor 110, as an example, row by row, using a single (dark) test frame. If the number of bright pixels exceeds a preset threshold, such as the size of the table, the device would be deemed to have failed self-test. During normal imaging operation in which image data from sensor 110 is corrected by image processor 130, interpolation would be used based on data stored in non-volatile memory 150 to replace defective pixel data with interpolated data from neighboring pixels. Many different interpolation methods may be used as are known to the art, ranging from simple averaging to more complex polynomial and spline methods. Defective pixels may also be located using this approach and flat field illumination.

The process for calibrating row and column noise or nonlinearities in sensor 110 is similar. Using dark or flat field illumination, row and column sums are accumulated in volatile memory 140. Row and column offset coefficients are determined from these sums and stored in non-volatile memory 150.

Blemish correction corrects for blemishes, typically dust particles, which occlude the surface of image sensor 110 or the optical path. Using flat field illumination, one implementation records a table of bounding rectangles noting blemishes. Bounding rectangles may be recorded as pairs of corners (e.g. upper left corner, lower right corner), corner and size (e.g. upper left corner, width, height), or other suitable methods. Another implementation records blemish location and a size code. If the number of blemishes exceed a threshold, or any single blemish exceeds a predetermined size threshold, the device would be deemed to have failed this test. During normal imaging operation, the blemish table stored in non-volatile memory 150 are used to replace blemished pixels with interpolated values from neighboring pixels.

Vignetting correction corrects for gradual non-uniformities in intensity and color. Using uniform fields, row and column sums from sensor 110 are stored in volatile memory 140 and used to determine a shading profile. Correction coefficients are determined from this data and stored in non-volatile correction memory 150.

Similar processes and their associated images may be used to perform color balance correction by using uniform fields of predetermined color temperatures. Correction of image distortion may be performed using images with known geometrical properties such as horizontal and/or vertical lines.

The code implementing the test, calibration, and correction processes may be stored in non-volatile memory associated with calibration processor 170, or in an extension of non-volatile correction memory 150. By using a higher-level protocol such as I2C, SPI, or the like on control interface 180, the contents of non-volatile memory 150 may be written through the control interface. While in one embodiment, all the code necessary for test, calibration, and correction are present within digital camera module 100, this code may also be loaded in stages. As an example, once a test or calibration stage has been completed and passed, code for the next stage could be loaded. At the end of calibration, correction code is loaded into the device, reclaiming at least some of the space used for testing and calibration.

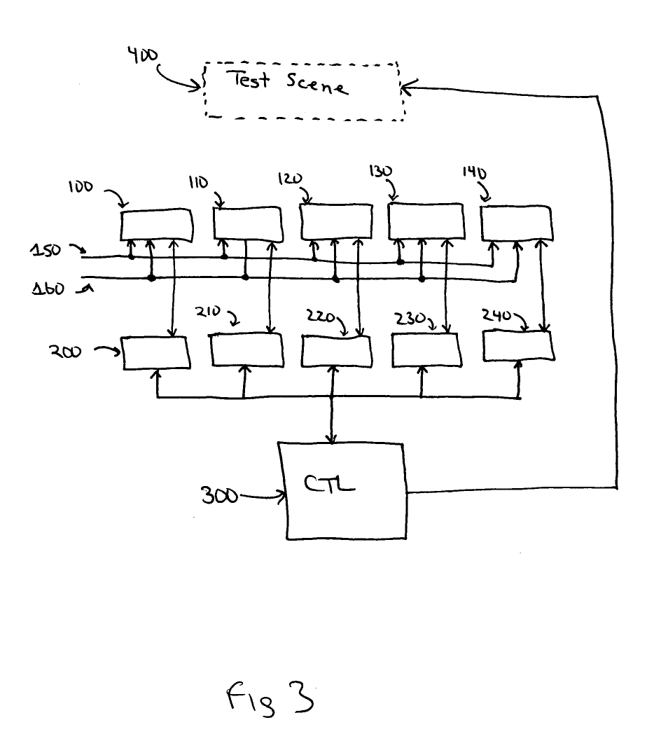

FIG. 3 shows an example of parallel calibration and test according to the present invention. Parallel operation decreases average test time, and therefore decreases test cost. Digital camera modules 100, 110, 120, 130, 140 as illustrated in FIG. 2 are supplied with power 150 and clock signals 160. Microcontrollers 200, 210, 220, 230, 240 communicate with their respective modules, driving control interface lines 180 of FIG. 2. and reporting status through communications bus 260 to test controller 300, which controls the test sequence, and also controls presentation of test scene 400. As compared to the system of FIG. 1, camera modules according to the present invention perform testing and calibration within the module itself, eliminating the need, for example, to transfer image data from the sensor to a separate device for testing and calibration.

Although the present invention has been described in detail it should be understood that various changes, substitutions, and alterations may be made without departing from the spirit and scope of the invention as defined by the appended claims.

What is claimed is:

1. A digital camera module comprising:
an image sensor,
an image processor receiving data from the image sensor and producing corrected image data,
a calibration processor receiving data from the image sensor,
volatile working memory for use by the image processor and calibration processor,
non-volatile memory for holding correction data generated by the correction processor for use by the image processor, and
a control processor with control inputs controlling the operation of the image sensor, calibration processor, and image processor.

2. The digital camera module of claim 1 where the image sensor, calibration processor, control processor, and image processor are manufactured on a single integrated circuit.

3. The digital camera module of claim 1 where the image sensor, calibration processor, control processor, image processor, and volatile working memory are manufactured on a single integrated circuit.

4. The digital camera module of claim 1 where the image sensor, calibration processor, control processor, image processor, volatile working memory, and non-volatile memory are manufactured on a single integrated circuit.

5. The digital camera module of claim 1 where the calibration processor and the image processor are implemented using a common digital signal processor.

6. The digital camera module of claim 1 where the non-volatile memory is a write-once memory.

7. The digital camera module of claim 1 where the non-volatile memory is a rewriteable memory.

8. The digital camera module of claim 1 where the control inputs select from a plurality of operating modes including at least one mode where the calibration processor analyzes the output of the image sensor responding to a preselected test image and writes correction data to the non-volatile memory.

9. The digital camera module of claim 8 where the control processor includes an output signal responsive to the calibration processor to indicate to external circuitry whether the module passed or failed predetermined criteria in analyzing the output of the image sensor responding to the preselected test image.

10. The digital camera module of claim 8 where the calibration processor is responsive to a plurality of test images.

11. The digital camera module of claim 10 where the calibration processor responding to a test image writes correction data to the nonvolatile memory for correcting fixed pattern noise.

12. The digital camera module of claim 10 where the calibration processor responding to a test image writes correction data to the nonvolatile memory for correcting row and/or column noise.

13. The digital camera module of claim 10 where the calibration processor responding to a test image writes correction data to the nonvolatile memory for correcting blemishes.

14. The digital camera module of claim 10 where the calibration processor responding to a test image writes correction data to the nonvolatile memory for correcting vignetting.

15. The digital camera module of claim 10 where the calibration processor responding to a test image writes correction data to the nonvolatile memory for correcting color balance.
